(19) United States
(12) Patent Application Publication
(10) Pub. No.: US 2008/0130422 A1
(43) Pub. Date: Jun. 5, 2008

(54) Countdown timing

(76) Inventor: Adam B. Hocherman, Boston, MA (US)

Correspondence Address: FISH & RICHARDSON PC, P.O. BOX 1022, MINNEAPOLIS, MN, 55440-1022, US

(21) Appl. No.: 11/633,357

(22) Filed: Dec. 4, 2006

(51) Int. Cl. G04F 10/00

(52) U.S. Cl. 368/107

(57) ABSTRACT

Among other things, a programmable, microprocessor-based timing device provides multiple, independent countdown-type timers in conjunction with a visual metaphor that provides a unique way to visually organize the timers such that multiple timers operating concurrently can be quickly associated with the item or items being timed.

This description relates to countdown timing.

Typically, a countdown timer is used to time an activity, such as a period of simmering a vegetable, in the case of cooking on a stovetop.

In general, in an aspect, countdown timings of a selection of one or more activities are performed simultaneously. A visual cue is provided that enables a user to visually associate an aspect of each of the countdown timings with a corresponding one of the activities.

Implementations may include one or more of the following features. The visual cue includes a configuration of indicators that correspond to a physical configuration associated with the activities. The activities include cooking activities, the physical configuration includes the configuration of burners on a stove, and the visual cue includes indicators in an arrangement corresponding to the configuration of burners. There are four activities and the visual cue includes four corresponding indicators each to indicate a status of a corresponding countdown timing. An amount of time is displayed corresponding to at least one of the countdown timings. Amounts of time corresponding to the countdown timings are displayed. An amount of time corresponding to one of the countdown timings is displayed and a user is enabled to select which of a second one of the countdown timings to display simultaneously with the one countdown timing. For the second one of the countdown timings selected by the user, a second visual cue is also displayed to indicate which of the countdown timings is being displayed. The visual cue indicates for which of one or more of the activities, countdown timings are simultaneously being performed. An alarm is issued when each of the countdown timings has expired. When at least one of the countdown timings has expired, counting up is commenced to indicate how much time has passed since the countdown timing has completed.

In general, in an aspect, a visual cue is provided of an association of a status of each of two or more countdown timings with corresponding activities being timed.

Implementations may include one or more of the following features. The visual cue includes an arrangement of lights corresponding to an arrangement of the activities being timed. The activities being timed include cooking activities on burners of a cook top, and the visual cue associates the status of each of two or more countdown timings of the activities with respective ones of the cooking activities. The visual cue includes four lights each of which indicates whether a countdown timing is active for a corresponding one of four burners of a cook top. Each of the lights has two visual states corresponding to two different states of the countdown timing. A display is configured to show an amount of time associated with one or more of the countdown timings. A control enables a user to select each of the countdown timings and to set a value for an amount of time for the countdown timing. The control includes two coaxial knobs. One of the knobs is biased to return to a center position and has a limited range of rotation in each direction. In some implementations, the timer includes a self-contained portable device. In some implementations, the timer is integrated into a device that has functions related to the activities with which the countdown timings are associated.

In general, in an aspect, a timer includes circuitry to perform countdown timings of one or more selected activities, and two coaxial rotary knobs, one knob having positions associated with one of the countdown timings for one of the activities that may be selected, the other knob being rotatable continuously to indicate an amount of time corresponding to the selected countdown timing.

Implementations may include one or more of the following features. The amount of time represented by a given angular rotation of the other knob depends on a state of the timer. The position of the one knob indicates which of the countdown timings has an active association with a function of the timer. The function of the timer with which the indicated countdown timing has an association includes selecting a running or paused state of the countdown timing. The function of the timer with which the indicated countdown timing has an association includes a display of an amount of time being counted by the countdown timing. The second knob is rotatable continuously in either direction. A control is provided to silence an alarm associated with one of the countdown timings. A control is provided to specify for which of the countdown timings the amount of time is shown on a display. Indicators are associated with states of respective ones of the countdown timings. The indicators have different visual states corresponding to different states of the corresponding countdown timers. The different visual states include at least one of color, brightness, and continuity. A clock function is provided.

In general, in an aspect, countdown timing is done for an activity, for a time period set by a user, until the time has expired. An alarm is issued when the time has expired. The user is enabled to terminate the alarm. Beginning when the time has expired, counting up is done, and the amount of time counted up after the time of the countdown timing completed is displayed.

Implementations may include one or more of the following features. The counting up is terminated when the user has terminated the alarm. A user is enabled to set countdown times for more than one activity. An alarm is issued when each of the times has expired. The user is enabled to terminate each of the alarms. Beginning when each of the times has expired, counting up is done, and the amount of time counted up after the time of the countdown timing completed is displayed for each of the activities. A user is enabled to restore a previously entered countdown time without having to set the time again.

These and other aspects and features, and combinations of them, can be expressed as methods, apparatus, systems, program products, as means for performing a function, and in other ways.

Advantages of what is described here include one or more of the following. The device provides a unique way to visually organize running timers such that timers operating concurrently can be quickly associated with the item or items being timed with just a glance. The device is easy to set. The user interface is designed to handle intuitively the complexity introduced by incorporating a plurality of timers. Further, the device provides its features in an elegant and inexpensive fashion.

Other advantages and features will become apparent from the following description and from the claims.

### DESCRIPTION

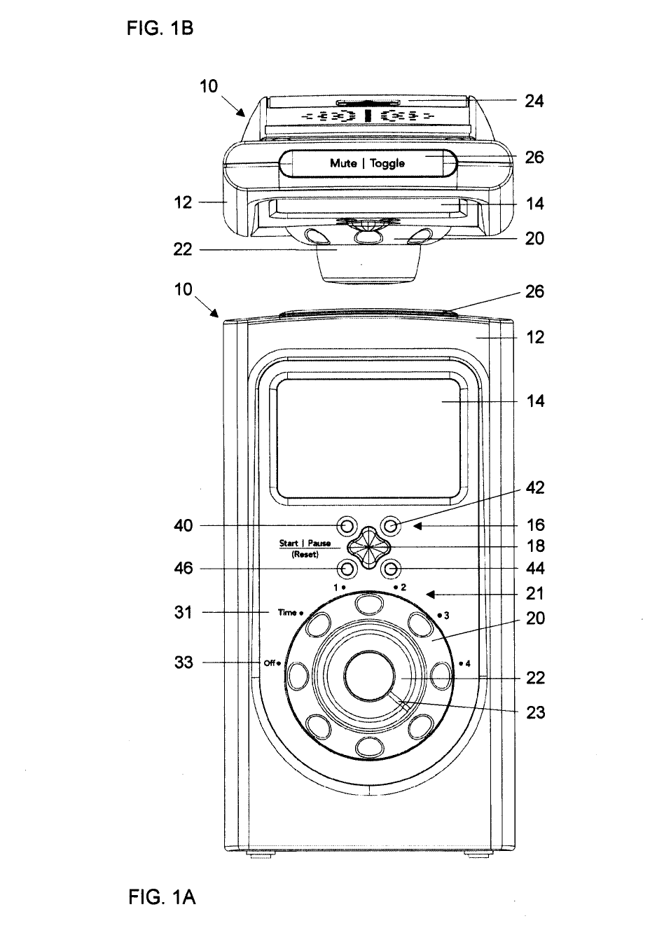

FIGS. 1A and 1B are a front view and a top view of a timer.

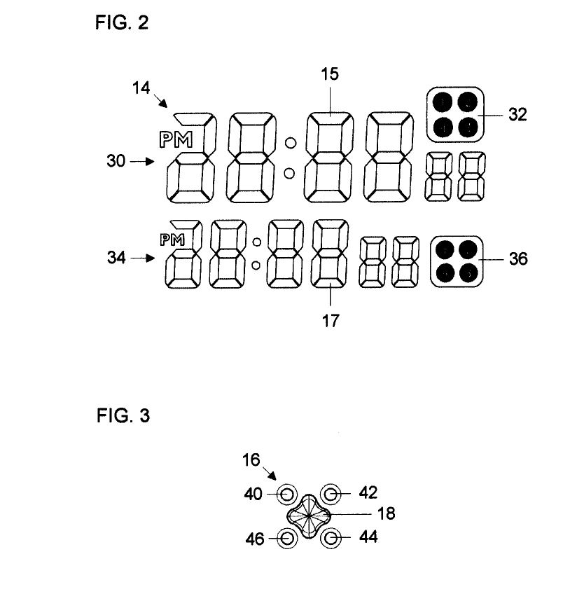

FIG. 2 is a view of an LCD display.

FIG. 3 is a view of an LED array.

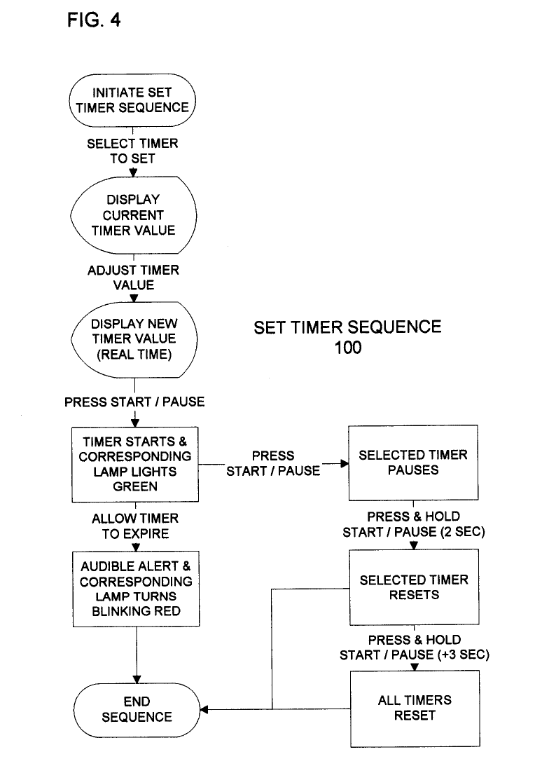

FIG. 4 is a flowchart.

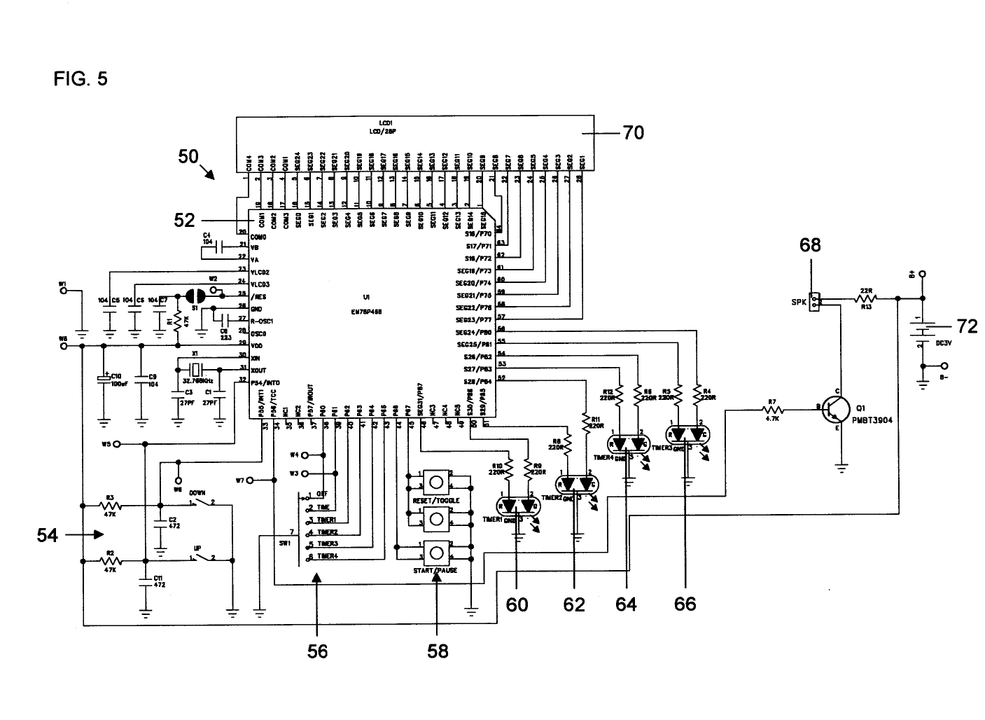

FIG. 5 is a circuit diagram.

As shown in the example implementation of FIGS. 1A and 1B, a timer 10 (an example of a “device”) has a housing 12 containing a display 14 located on a front side of the device. Also on the front, below the display, are located an array of LEDs 16 (which we sometimes call a “burner array”). In the center of the burner array 16 is a ‘Start/Pause’ momentary contact push-button switch 18. Functionality of this switch is described below. Below the burner array 16 and ‘Start/Pause’ switch 18, a value input collar 20 (sometimes called a “knob”) rotates freely and independently either clockwise (for incrementing values) or counterclockwise (for decrementing values) around a mode selector knob 22. The mode selector knob, which is coaxial with the value input collar, enables a user to select different countdown timers and in other ways control the status of the device, the countdown timers, and the display.

According to some examples, a ‘Mute/Toggle’ switch 26 is located on the top side of the device. Functionality of this switch is described below.

A removable battery door 24 is located on the back side of the device and conceals the batteries used to power the timer.

As shown in FIG. 2 an example display 14 includes two regions 30, 34. A main display region 30 includes digital clock display elements 15 and an associated set of main display burner icons 32. A sub-display region 34 includes digital clock display elements 17 and an associated set of sub-display burner icons 36. Functionality of the example display is described below.

As shown in FIG. 3 an example burner array 16 includes four (4) dual-color LEDs 40-46 arranged such that the four lamps are placed at the corners of a virtual square. In some embodiments, these lamps are meant to represent the similarly arranged coils on a four-burner stove or cook top. In some embodiments these lamps may number more or less than four and/or may be arranged in the shape of a rectangle, triangle, or any shape that is convenient for conveying information about what the lamps are meant to represent or the activities with which they are associated. The arrangement of the four lamps provides a visual cue to a user of the device to enable the user to visually associate aspects of each of the countdown timings performed by the timers with a cooking operation (or other activity) occurring on the corresponding burner. Functionality surrounding the example burner array is described below.

FIG. 4 illustrates one example of a ‘Set Timer Sequence’ 100. In implementations of this example, a user of the device initiates the sequence by positioning the mode selector knob 22 so that a marker 23 points to one of several (for example, four) numbered positions 21 labeled on the front face of the device. The numbered positions correspond to the burners as labeled in the main display burner icons 32 and sub-display burner icons 36. The same relative positions are implied with regard to the burner array 16. Each burner corresponds to one countdown timer. The selected burner (and hence the selected timer) is sometimes referred to as an “active” timer and is the timer which (a) is visible in the main display region 30 and (b) responds to inputs from the value input collar 20. The main display burner icon 32 that corresponds to the currently active timer is displayed in a different style, color or brightness than the other icons of the set.

Next in the sequence of FIG. 4, a user of the device adjusts the selected timer value (the amount of time to be counted down) by rotating the value input collar 20 either clockwise to increment the value or counter-clockwise to decrement the value. In at least some embodiments, the step size of the increment or decrement is dependent on how much total time is displayed for that timer (or in other ways on the state of the timer or its elements). If the total is between 0 and 30 minutes, the step value is 1 minute. Between 30 minutes and 2 hours, the step value is 5 mins. Between 2 hours and 24 hours, the step value is 15 mins. The timer value loops back to 0 or to the highest possible value at the extreme ends of this range. Other step sizes and ranges of time to which they apply could be used. In at least some embodiments, a timer value may also be adjusted while the active timer is running.

Next in the sequence, the ‘Start/Pause’ switch 18 is pressed to begin the active timer countdown towards zero. In at least some embodiments, the corresponding dual-color LED 40-46 illuminates in green to indicate the presence of a running timer in that relative location. Repeatedly pressing the ‘Start/Pause’ switch 18 alternately pauses and restarts the active timer. In at least some embodiments, if the switch 18 is pressed and held for two (2) seconds, the active timer is reset to zero. In at least some embodiments, if the switch 18 is continued to be held for three (3) additional seconds, all timers are reset to zero.

When a running timer expires (that is, the countdown timing ends or reaches 0:00:00), an audible tone (an example of an alarm) sounds and the corresponding dual-color LED 40-46 flashes in a red color. In at least some embodiments, upon expiration, the expired timer value flashes in the display and the timer proceeds to count up from 0:00:00 in order to indicate the time that has elapsed since expiration. In some examples, the duration of the audible tone is one minute before it is muted automatically. In some examples, the maximum count-up duration after timer expiration is one hour. By counting up time after the countdown timer has expired, and displaying the counted up time, a user can know, for example, how long the beef stew (for example) has cooked beyond the originally intended time.

In some examples there exists a “batch” feature. If a user would like to repeat the same countdown duration that just expired on the active timer, the ‘Start/Pause’ switch 18 is pressed, thus recalling that value. Once recalled, that value may be adjusted using the value input collar 20 prior to commencing the countdown using ‘Start/Pause’ switch 18.

In some examples, additional timers may be caused to run at the same time that the first timer is running. Use of the mode selector knob 22, value input collar 20, and the ‘Start/Pause’ switch 18 to select, set, and begin countdown of a second running timer in the main display region 30 causes the first running timer to be automatically displayed in the sub-display region 34. Additional timers can also be selected, set, and triggered to count down. Furthermore, in some examples, if one or more timers are running or paused (but not expired), the ‘Mute/Toggle’ switch 26 may be used to repeatedly cycle the timer value viewable in the sub-display region 34. The timer viewable in the main display region 30 may be changed using the mode selector knob 22 (and in the process be made the “active” timer). The burner icons 32 and 36 indicate which timer is currently visible in the associated display region 30 and 34, respectively. In some examples, after all timers are cycled in the sub-display, an additional press of the ‘Mute/Toggle’ switch 26 clears that display region prior to repeating the cycle.

In some examples, the ‘Mute/Toggle’ switch 26 may be used to silence one or more expired timer(s) and to reset the related count-up timer(s) to zero.

In the example circuit 50 shown in FIG. 5, a central Microprocessing Unit (MPU) 52 receives user inputs via momentary contact switches 58, mode selector knob circuitry 56, and value input circuitry 54. Visual and/or aural feedback is provided to the user via dual-color LEDs 60-66, speaker 68, and LCD 70. Power to the circuit is provided by batteries 72. Software run by the MPU effects the functions and processes described here and could be adjusted to provided variations in the functions and processes. The functions and processes could be implemented by any combination of hardware, software, and firmware on a wide variety of platforms.

In some examples of the device, a user may opt to display the current time of day by using the mode selector knob 22 to select a ‘Time’ mode 31. In these examples, a ‘Set Time of Day’ sequence is invoked by pressing and holding ‘Start/Pause’ switch 18 for two (2) seconds while the mode selector knob 22 is in the ‘Time’ position. Upon invocation, the display flashes either ‘12 Hr’ or ‘24 Hr’ which may be toggled by rotating value input collar 20. Pressing the ‘Start/Pause’ switch 18 locks in the user selection and flashes the current time of day on the display which may subsequently be adjusted in the same manner. A final press of the ‘Start/Pause’ switch 18 confirms the user-entered time of day and returns the device to ordinary ‘Time’ mode.

In some examples of the device there exists an ‘Off’ mode 33. When a user positions the mode selector knob 22 to this position any running timers are paused and the display 14 is turned off to save power. The paused values of the previously running timers are retained and the user may choose to resume countdown for one or more of these timers by repositioning the mode selector knob 22 to one of the corresponding numbered positions 21 and pressing the ‘Start/Pause’ switch 18 to resume operation.

Other implementations are also within the scope of the following claims.

For example, the activities that are the subject of the countdown timings need not be cooking operations on burners but could be any kind of activities at all for which a user wishes to perform one or more countdown timings. The visual cue provided to the user need not be in the form of an array of lights, but rather any kind of a broad range of visual cues could be provided as long as they enable a user to visually associate each of the countdown timings with a corresponding one of the activities. The device can be a stand alone handheld device and may also be integrated into another device, such as a stove. The visual cue can be provided in other ways than using lamps.

1. A method comprising
performing countdown timings of a selection of one or more activities simultaneously, and
providing a visual cue that enables a user to visually associate an aspect of each of the countdown timings with a corresponding one of the activities.

2. The method of claim 1 in which the visual cue comprises a configuration of indicators that correspond to a physical configuration associated with the activities.

3. The method of claim 2 in which the activities comprise cooking activities, the physical configuration comprises the configuration of burners on a stove, and the visual cue comprises indicators in an arrangement corresponding to the configuration of burners.

4. The method of claim 1 in which there are four activities and the visual cue includes four corresponding indicators each to indicate a status of a corresponding countdown timing.

5. The method of claim 1 also including displaying an amount of time corresponding to at least one of the countdown timings.

6. The method of claim 1 also including simultaneously displaying amounts of time corresponding to at least two of the countdown timings.

7. The method of claim 1 also including displaying an amount of time corresponding to one of the countdown timings and enabling a user to select which of a second one of the countdown timings to display simultaneously with the one countdown timing.

8. The method of claim 7 also including, for the second one of the countdown timings selected by the user, also displaying a second visual cue to indicate which of the countdown timings is being displayed.

9. The method of claim 1 in which the visual cue indicates for which of one or more of the activities, countdown timings are simultaneously being performed.

10. The method of claim 1 also including issuing an alarm when each of the countdown timings has expired.

11. The method of claim 1 also including, when at least one of the countdown timings has expired, continuing to count up to indicate how much time has passed since the countdown timing has completed.

12. An apparatus comprising
circuitry to count down time for a selected number of one or more activities simultaneously, and
a visual cue to enable a user of the circuitry to visually associate an aspect of each of the countdown timings with a corresponding one of the activities.

13. A medium bearing instructions to cause a device to
countdown time for a selected number of one or more activities simultaneously, and
provide a visual cue that associates an aspect of each of the countdown timings with a corresponding one of the activities.

14. A timer comprising
a visual cue of an association of a status of each of two or more countdown timings with corresponding activities being timed.

15. The timer of claim 14 in which the visual cue comprises an arrangement of lights corresponding to an arrangement of the activities being timed.

16. The timer of claim 14 in which the activities being timed comprise cooking activities on burners of a cook top, and the visual cue associates the status of each of two or more countdown timings of the activities with respective ones of the cooking activities.

17. The timer of claim 14 in which the visual cue comprises four lights each of which indicates whether a countdown timing is active for a corresponding one of four burners of a cook top.

18. The timer of claim 17 in which each of the lights has two visual states corresponding to two different states of the countdown timing.

19. The timer of claim 14 comprising a self-contained portable device.

20. The timer of claim 14 integrated into a device that has functions related to the activities with which the countdown timings are associated.

21. The timer of claim 14 also including a display configured to show an amount of time associated with one or more of the countdown timings.

22. The timer of claim 14 also including a control to enable a user to select each of the countdown timings and to set a value for an amount of time for the countdown timing.

23. The timer of claim 22 in which the control comprises two coaxial knobs.

24. A timer comprising
circuitry to perform countdown timings of one or more selected activities, and
two coaxial rotary knobs, one knob having positions associated with one of the countdown timings for one of the activities that may be selected, the other knob being rotatable continuously to indicate an amount of time corresponding to the selected countdown timing.

25. The timer of claim 24 in which the amount of time represented by a given angular rotation of the other knob depends on a state of the timer.

26. The timer of claim 24 in which the position of the one knob indicates which of the countdown timings has an active association with a function of the timer.

27. The timer of claim 26 in which the function of the timer with which the indicated countdown timing has an association comprises selecting a running or paused state of the countdown timing.

28. The timer of claim 26 in which the function of the timer with which the indicated countdown timing has an association comprises a display of an amount of time being counted by the countdown timing.

29. The timer of claim 24 in which the second knob is rotatable continuously in either direction.

30. The timer of claim 24 also including a control to silence an alarm associated with one of the countdown timings.

31. The timer of claim 24 also including a control to specify for which of the countdown timings the amount of time is shown on a display.

32. The timer of claim 24 also including indicators associated with states of respective ones of the countdown timings.

33. The timer of claim 32 in which the indicators have different visual states corresponding to different states of the corresponding countdown timers.

34. The timer of claim 33 in which the different visual states include at least one of color, brightness, and continuity.

35. The timer of claim 24 also including a clock function.

36. A method comprising
countdown timing an activity for a time set by a user until the time has expired,
issuing an alarm when the time has expired,
enabling the user to terminate the alarm,
beginning when the time has expired, counting up, and
displaying to the user the amount of time counted up after the time of the countdown timing completed.

37. The method of claim 36 including terminating the counting up when the user has terminated the alarm.

38. The method of claim 36 also including enabling a user to set countdown times for more than one activity, issuing an alarm when each of the times has expired, enabling the user to terminate each of the alarms, beginning when each of the times has expired, counting up, and displaying to the user the amount of time counted up after the time of the countdown timing completed for each of the activities.

39. The method of claim 36 also including enabling a user to restore a previously entered countdown time without having to set the time again.

40. The method of claim 5 also including displaying a second visual cue to indicate which of the countdown timings is being displayed.

41. The timer of claim 24 in which the second knob is biased to return to a center position and has a limited range of rotation in each direction.
